(19) United States
(12) Patent Application Publication
(10) Pub. No.: US 2007/0113652 A1
(43) Pub. Date: May 24, 2007

(54) Wireless Position Sensing Wafer

(76) Inventor: Wayne Glenn Renken, San Jose, CA (US)

Correspondence Address: PARSONS HSUE & DE RUNTZ LLP, 595 MARKET STREET, SUITE 1900, SAN FRANCISCO, CA, 94105, US

(21) Appl. No.: 11/539,465

(22) Filed: Oct. 6, 2006

Related U.S. Application Data
(60) Provisional application No. 60/724,712, filed on Oct. 7, 2005.

(51) Int. Cl. G01P 15/00; G01D 21/02

(52) U.S. Cl. 73/509

(57) ABSTRACT

A wireless position sensing wafer includes at least one accelerometer that measures acceleration along one direction. Integrating acceleration allows velocity and displacement from a starting point to be obtained. Orientation may be obtained from one or more gyroscopes or from a magnetic sensor. One or more artificial magnetic fields may be created for such a magnetic sensor. Position may also be found by triangulation with respect to fixed transmitters.

### CROSS REFERENCE TO RELATED APPLICATION

This non-provisional application claims the benefit of provisional application no. 60/724,712, filed Oct. 7, 2005, which application is incorporated herein in its entirety by this reference.

### BACKGROUND

This application relates to devices for measuring process conditions. In particular, this application relates to devices that can determine location within a process environment.

In various industries, substrates are processed by automated equipment that moves the substrates from one location to another with little or no human intervention. In order to setup and maintain such equipment, it is desirable to track the movement of an individual substrate to determine its precise path and to learn what mechanical experiences it undergoes. For example, it may be desirable to know if any mechanical shock or vibration is experienced. It may also be desirable to know the orientation of the substrate as it progresses along its path. Examples of substrates that are processed by automated equipment include semiconductor wafers and flat panel display substrates. Determining the exact position of a substrate or measuring mechanical variables experienced by the substrate may be difficult because of the environment in which the substrate is handled. For example, the substrate may be enclosed in a chamber having chamber walls that prevent easy access for measuring. The chamber may have a controlled environment, for example it may be under vacuum, under pressure or at a controlled (high or low) temperature, making access difficult without disturbing the environment.

### SUMMARY

In one example, a wireless position sensing wafer includes at least one accelerometer that measures acceleration in one direction. Displacement along the direction from a starting point can be derived from readings from the accelerometer. Using two or three such accelerometers, displacement in two or three dimensions may be obtained. Accelerometers may also provide information regarding vibration or shock.

A wireless position sensing wafer may include one or more gyroscopes to determine orientation. Using three such gyroscopes, tilt and yaw of a wafer may be measured. Where a wireless position sensing wafer includes both accelerometers and gyroscopes, both position and orientation may be determined at any time.

In one embodiment, an external magnetic field is provided so that orientation of a wafer may be determined with respect to the field by a magnetic sensor. Two or more fields may be provided with different orientations. Time-varying magnetic fields may be used so that different fields are distinguishable.

In another embodiment, a position sensing wafer uses triangulation to establish its position with respect to transmitters having fixed locations.

A position sensing wafer may be considered a Process Condition Measuring Device (PCMD) and may include additional sensors to measure process conditions including: temperature, pressure and gas flow rates.

### BRIEF DESCRIPTION OF THE DRAWINGS

FIG. 1 shows a position sensing wafer including position sensing circuits according to an embodiment of the present invention.

FIG. 2 shows a semiconductor processing tool from above.

FIG. 3 shows the semiconductor processing tool of FIG. 2 from one side.

FIG. 4 shows position sensing circuits of FIG. 1 in more detail.

FIG. 5 shows alternative positioning sensing circuits.

FIG. 6 shows a sensing wafer in an artificially generated magnetic field.

FIG. 7 shows a position sensing wafer that determines position from fixed transmitters.

### DETAILED DESCRIPTION

A Process Condition Measuring Device (PCMD) that is similar in size and shape to a substrate, and that measures environmental variables experienced by the PCMD as it is handled by automated equipment is described in US Patent Application Publication No. 20040225462, entitled “Integrated Process Condition Sensing Wafer and Data Analysis System,” which patent application is hereby incorporated by reference in its entirety for all purposes. Circuitry on a PCMD may allow collected data from one or more sensors to be stored on the PCMD, or to be transmitted from the PCMD to another location.

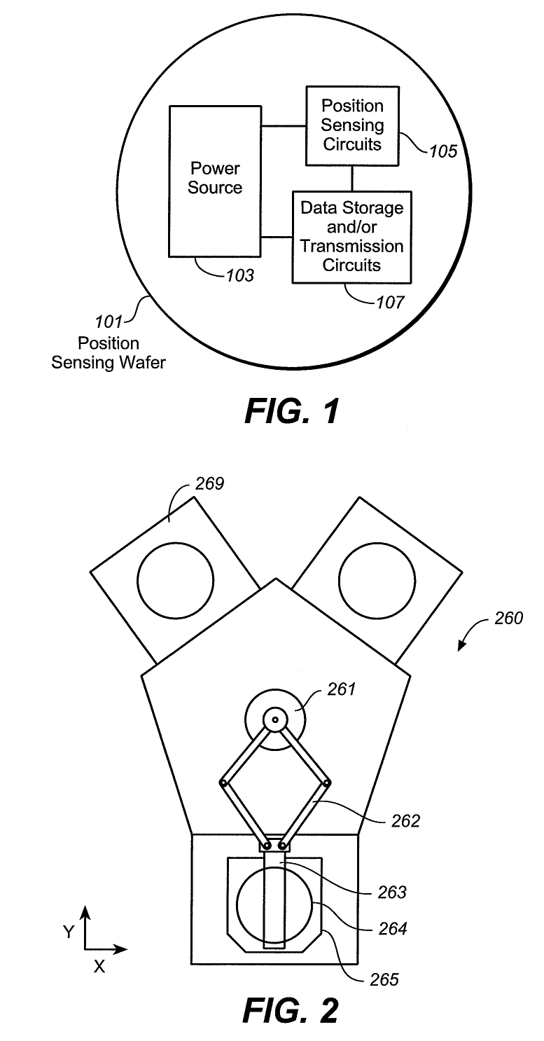

FIG. 1 shows a position sensing wafer 101. In this example, position sensing wafer 101 is similar in size and shape to a silicon wafer used to manufacture integrated circuits (e.g. 300 mm diameter). In other examples, other substrates may be used including different sized wafers and other substrates. Position sensing wafer 101 includes a power source 103, position sensing circuits 105 and data storage and/or transmission circuits 107. Position sensing wafer 101 may be formed in a similar manner and may contain many of the same components as a PCMD as described in US Patent Application Publication No. 20040225462.

Power source 103 may be any suitable source of electrical power to run electronic circuits. Power source 103 may be a battery that is rechargeable or replaceable. In some examples, RF induction circuits are provided so that power can be transmitted wirelessly to a power source to enable wireless recharging of a battery. Alternatively, probes may be used to form electrical connections to pads on a position sensing wafer to supply electrical current to recharge a battery.

Position sensing circuits 105 may be any circuits that allow a determination of position to be made. In many cases, this means that the position is determined in three dimensions. However, in some cases, position in one or more dimension is known or unnecessary so that position in only one or two dimensions is needed. Position may be established from some starting point or with respect to some frame of reference that does not require a particular starting point. In some cases, a frame of reference is established by additional apparatus provided for that purpose. Various position sensing circuits are described further below. Positional data from position sensing circuits 105 is sent to data storage and/or transmission circuits 107. This data may be sent periodically or according to some algorithm that varies the sampling frequency. In addition to positional information, some sensing circuits provide data regarding the orientation of a position sensing wafer. Thus, the tilt and yaw of a position sensing wafer may be measured by position sensing wafer. Tilt occurs when the plane of the wafer is rotated from a horizontal plane, e.g. rotated about the X-axis or Y-axis. Yaw is a condition where the wafer is rotated about a vertical axis, i.e. rotated in a horizontal plane. In addition, position sensing circuits 105 may measure vibration and shock and provide data regarding these parameters.

Data storage and/or transmission circuits 107 receive position, orientation or other data from position sensing circuits 105. Circuits 107 then store this data for later retrieval in some cases, for example in a non-volatile memory. In other examples, circuits 107 transmit data to a remote location as the data are received. Transmission may be wireless in some examples, though wires may also be used in some examples. Data may also be stored for some time before the data are transmitted. At the remote location where the data are retrieved or received, the data may be used to make determinations regarding the equipment.

FIG. 2 shows cut-away view of a semiconductor processing tool 260 from above. A robot 261 is located in processing tool 260. Robot 261 has arms 262 that extend a blade 263 that is used to pick up a wafer 264 from a cassette 265. After wafer 264 is picked up from cassette 265 it is moved to processing chamber 269 where it undergoes a process such as deposition of a material or etching. The view in FIG. 2 shows the tool from above, i.e. extending in a horizontal plane shown by the X-axis and Y-axis indicators.

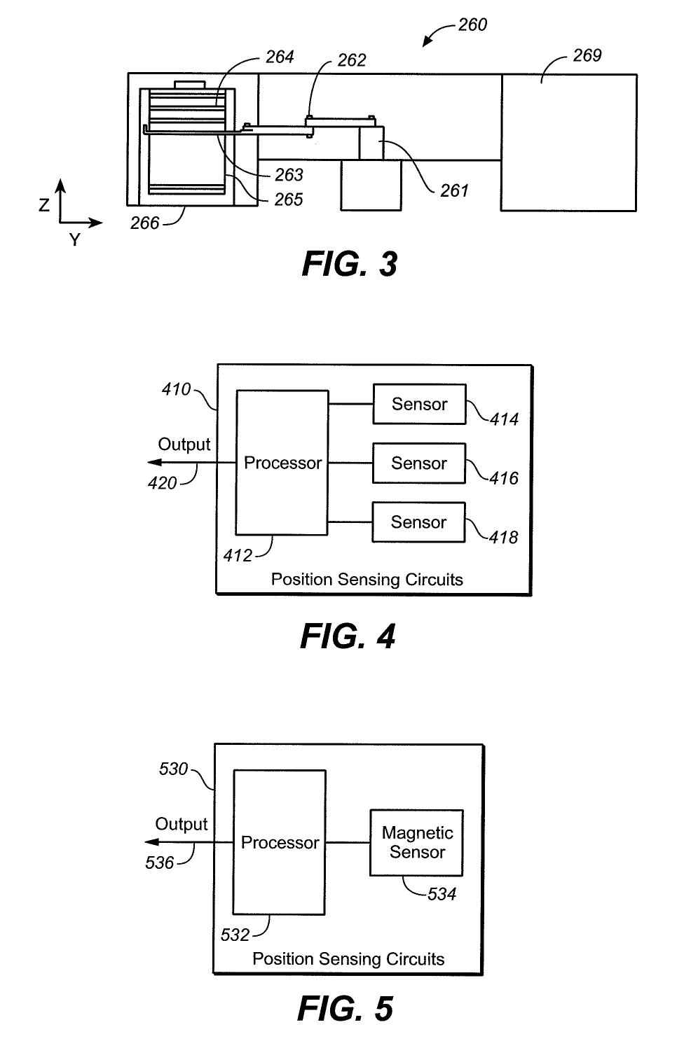

FIG. 3 shows a cut-away view of semiconductor processing tool 260 from one side. The Y-axis and Z-axis are indicated accordingly. Clearly, a wafer in semiconductor processing tool 260 moves along the X and Y-axis as it is transferred from cassette 265 to processing chamber 269. In addition, a wafer may move along the Z-axis as it is moved, for example when being lifted out of cassette 265 or being “dropped” in processing chamber 269. During initial calibration, it is useful to gather data on the path of a wafer moving through a tool such as semiconductor processing tool 260 so that robot 261 may be calibrated. Other mechanical components may also be calibrated in this way including any mechanism for moving wafers while in cassette 265 or in processing chamber 269. In addition, it may be useful to gather data on the movement of a wafer for troubleshooting purposes after installation. For example, delays at various points along a wafers path may cause temperature changes. Variation in handling from one wafer to another may cause variation in the devices obtained which may lead to yield loss.

FIG. 4 shows a first example of position sensing circuits 410 that may be used as position sensing circuits 105 in position sensing wafer 101. Position sensing circuits 410 include a processor 412 connected to sensors 414, 416, 418. Sensors 414, 416, 418 provide data regarding parameters such as position, orientation, and acceleration. Sensors 414, 416, 418 may be formed by Micro-Electro-Mechanical-Systems (MEMS) technology. Such MEMS sensors are widely used, for example in the automobile industry. MEMS sensors include accelerometers and gyroscopes.

In one example, sensor 414 is an accelerometer aligned to measure acceleration along the X-axis, sensor 416 is an accelerometer aligned to measure acceleration along the Y-axis and sensor 418 is an accelerometer aligned to measure acceleration along the Z-axis. Sensors 414, 416, 418 send acceleration data to processor 412 where it is used to calculate displacement from a starting point. The starting point is generally some point where position is precisely established. The wafer is placed at the starting point and sensing by sensors 414, 416, 418 begins with the wafer at rest so that both velocity and acceleration are at zero. Any acceleration (change in velocity) is measured so that the velocity can be derived at any time. Because velocity is known at any time, displacement from the starting point can also be derived by processor 412. Thus, sensors 414, 416, 418 allow the displacement of a substrate from a starting point to be determined as it is moved along its path. In some cases, one or two sensors could be used to determine displacement in one or two dimensions in a similar manner. In addition to measuring acceleration, sensors 414, 416, 418 or other additional sensors may sense vibration or shock. Data from sensors 414, 416, 418 may be processed and used to derive data that is sent to output 420. Alternatively, raw data from sensors 414, 416, 418 may be sent directly to output 420. Output 420 connects to data storage and/or transmission circuits.

In another example, sensors 414, 416, 418 are gyroscopes that measure angular change. Thus, sensors 414, 416, 418 may give data regarding the orientation of the wafer about three axes (both tilt and yaw). In some examples, such gyroscopes are combined with other sensors, such as accelerometers or other sensors to provide additional data. Examples of both MEMS accelerometers and gyroscopes that may be used as sensors 414, 416, 418 include various MEMS products made by Analog Devices such as iMEMS accelerometers and iMEMS gyroscopes.

FIG. 5 shows alternative position sensing circuits 530 that may be used as position sensing circuits 105 in position sensing wafer 101. Position sensing circuits 530 include a processor 532 connected to a magnetic sensor 534. Magnetic sensor 534 may simply detect the direction of the magnetic field at the location of magnetic sensor 534, i.e. magnetic sensor 534 may be a compass. In other examples, magnetic sensor 534 measures magnetic field strength. Using the earth's magnetic field alone, position sensing circuits may be able to determine the orientation of a wafer by acting as a compass. However, the earth's magnetic field may be distorted by nearby electrical currents or ferromagnetic components so that the earth's magnetic field alone may not be reliable.

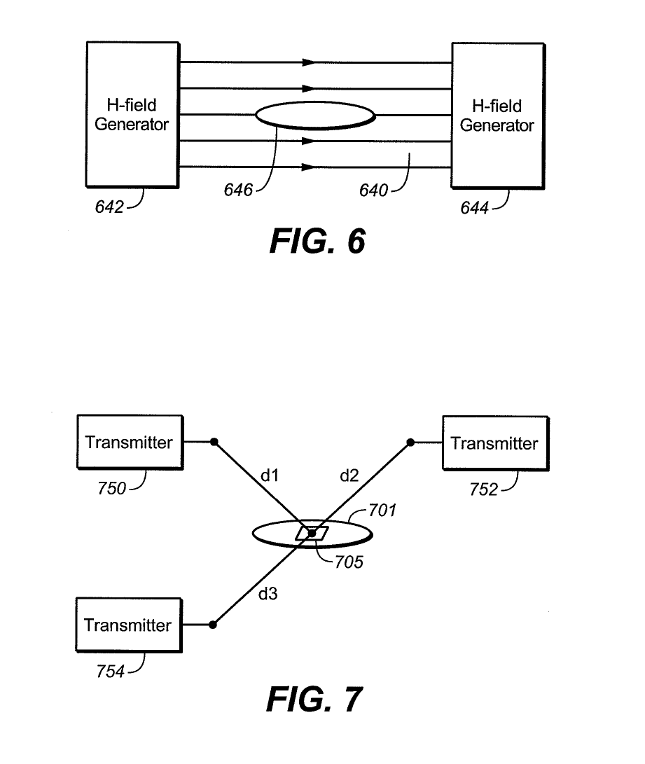

In one embodiment, shown in FIG. 6, a magnetic field (H-field) 640 is artificially created by magnetic field generators 642, 644 in the area in which a sensing wafer 646 is used so that sensing wafer 646 does not have to rely on the earth's magnetic field. A magnetic field may be created using permanent magnets or electromagnets. In one example, an artificial magnetic field is a time-varying magnetic field created by electromagnets. For example, the magnetic field may have a periodic variation or may be pulsed. In some examples, multiple magnetic fields may be created in the same area having different frequencies and different orientations. In this way, data regarding the magnetic field measured by a sensor may be filtered according to frequency so that any background magnetic field is separated from an artificially generated periodic field, and different artificially generated fields may be distinguished.

FIG. 7 shows another example of apparatus for determining position of a wafer. Position sensing wafer 701 has position sensing circuits 705 that determine the position of wafer 701 with respect to transmitters 750, 752, 754 by triangulation. Transmitters 750, 752, 754 may be Ultra Wideband (UWB) transmitters for example. UWB transmitters generally send a pulsed signal over a wide bandwidth. The signals from transmitters 750, 752, 754 are received by position sensing circuits 705 and used to determine the distances d1, d2 and d3 from transmitters 750, 752 and 754 respectively. The system works similarly to the Global Positioning System (GPS) that uses satellites to accurately determine geographical position using signals from geostationary satellites. Here, instead of geostationary satellites, transmitters 750, 752, 754 are placed at known, fixed locations so that knowing distances d1, d2, d3, the position of wafer 701 is known. Other transmitters may also be used as transmitters 750, 752, 754. For example transmitters using Wi-Fi or some other wireless protocol may be used. Optical or acoustic transmitters could be similarly used. In some cases, more than three transmitters may be used to give greater positional accuracy or to extend the range over which wafer 701 may be moved while determining its position.

1. A process condition measuring device comprising:
a substrate having at least one dimension that is the same as a dimension of a Silicon wafer;
a position sensing circuit attached to the substrate, the position sensing circuit including at least one accelerometer, the position sensing circuit determining displacement from a starting location from an output of the accelerometer; and
an orientation sensing circuit attached to the substrate, the orientation sensing circuit including at least one gyroscope, the orientation sensing circuit determining orientation from the output of the at least one gyroscope.
